(19) United States
(12) Patent Application Publication
(10) Pub. No.: US 2016/0078556 A1
(43) Pub. Date: Mar. 17, 2016

(54) METHOD AND SYSTEM FOR ESTIMATION OF SMALL BUSINESS RISK AND SPEND PROFILES

(71) Applicant: MasterCard International Incorporated, Purchase, NY (US)

(72) Inventors: Ina GOLDBERG, New York, NY (US); Steven Joel Jonas, Westport, CT (US); Matthew Alcuri, Ridgefield, CT (US)

(73) Assignee: MasterCard International Incorporated, Purchase, NY (US)

(21) Appl. No.: 14/486,351

(22) Filed: Sep. 15, 2014

(51) Int. Cl. G06Q 40/00

(52) U.S. Cl. CPC G06Q 40/12

(57) ABSTRACT

A method for aggregating entity transaction data across multiple transaction accounts includes: storing a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity; receiving transaction data for a processed payment transaction, wherein the transaction data includes a specific unique entity identifier associated with an entity involved in the processed payment transaction and a separate account identifier associated with a transaction account used to fund the processed payment transaction; identifying a specific entity profile where the included unique entity identifier corresponds to the specific unique entity identifier; and storing, in the identified specific entity profile, the received transaction data.

### FIELD

The present disclosure relates to aggregation of payment transactions and estimation of risk and spend profiles, specifically the aggregation of transactions for a plurality of different accounts for a small business and use thereof to evaluate risk and spend profiles for the business.

### BACKGROUND

Merchants, acquirers, issuers, payment networks, and other entities are often interested in both the potential risks of a party involved in a transaction as well as the spend profile of various parties. Evaluation of the risk of a party in a transaction may be useful in determining the potential for fraud, which may guide various decisions, such as the decision to approve or deny a transaction, to extend an offer of credit to the party, etc. Similarly, a spend profile for a party may be useful when providing offers, discounts, rewards, or other content to the party that can be targeted based on their spend profile.

In many traditional methods and systems, a person or other entity, such as a business, may have their risk or spend profiles identified based on their transaction history for a particular transaction account. This may be suitable in instances where there is a single, primary account for the entity that is used for a majority of transactions, such as in many personal accounts. However, in instances where multiple accounts may be used, such methods may provide an inaccurate profile of the entity.

This may be increasingly inaccurate in small businesses, where an owner may use and maintain multiple accounts, such as using a personal account for business expenses as well as a business account for business expenses. In such instances, evaluating the risk or spending of the owner or the small business separately, or using only a single account, may be detrimental to the owner and/or small business, which may have negative consequences to not only the owner and their business, but to account issuers and other parties as well.

Thus, there is a need for a technical solution to evaluating the risk and spending of a small business that utilizes transaction history for the business across multiple accounts from multiple issuers and therefore provides a more accurate landscape of the small business's transaction activity.

### SUMMARY

The present disclosure provides a description of systems and methods for aggregating entity transactions and evaluating small business profiles.

A method for aggregating entity transaction data across multiple transaction accounts includes: storing, in a profile database, a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity; receiving, by a receiving device, transaction data for a processed payment transaction, wherein the transaction data includes at least a specific unique entity identifier associated with an entity involved in the processed payment transaction and a separate account identifier associated with a transaction account used to fund the processed payment transaction; identifying, in the profile database, a specific entity profile where the included unique entity identifier corresponds to the specific unique entity identifier; and storing, in the identified specific entity profile, the received transaction data.

A method for evaluation of a small business profile includes: storing, in an entity database, a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity; receiving, by a receiving device, transaction data for a payment transaction, wherein the transaction data includes at least a specific unique entity identifier associated with an entity involved in the payment transaction and a separate account identifier associated with a transaction account used to fund the payment transaction; identifying, in the entity database, a specific entity profile where the included unique entity identifier corresponds to the specific unique entity identifier; calculating, by a processing device, a score for the entity associated with the specific entity profile based on at least the transaction data included in one or more transaction data entries included in the specific entity profile; and transmitting, by a transmitting device, the calculated score in an authorization message associated with the payment transaction.

Another method for evaluation of a small business profile includes: storing, in an entity database, a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity; receiving, by a receiving device, a score request, wherein the score request includes a requested score and a set of one or more unique entity identifiers; identifying, in the entity database, a set of one or more entity profiles where the included unique entity identifier in each entity profile in the set of one or more entity profiles corresponds to the unique entity identifier in the set of one or more unique entity identifiers; calculating, by a processing device, the requested score for each entity associated with an entity profile in the identified set of one or more entity profiles based on at least the transaction data included in one or more transaction data entries included in the respective entity profile; and transmitting, by a transmitting device, the calculated score for each entity associated with an entity profile in the identified set of one or more entity profiles in response to the received score request.

A system for aggregating entity transaction data across multiple transaction accounts includes a profile database, a receiving device, and a processing device. The profile database is configured to store a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity. The receiving device is configured to receive transaction data for a processed payment transaction, wherein the transaction data includes at least a specific unique entity identifier associated with an entity involved in the processed payment transaction and a separate account identifier associated with a transaction account used to fund the processed payment transaction. The processing device is configured to: identify, in the profile database, a specific entity profile where the included unique entity identifier corresponds to the specific unique entity identifier; and store, in the identified specific entity profile, the received transaction data.

A system for evaluation of a small business profile includes an entity database, a receiving device, a processing device, and a transmitting device. The entity database is configured to store a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity. The receiving device is configured to receive transaction data for a payment transaction, wherein the transaction data includes at least a specific unique entity identifier associated with an entity involved in the payment transaction and a separate account identifier associated with a transaction account used to fund the payment transaction. The processing device is configured to: identify, in the entity database, a specific entity profile where the included unique entity identifier corresponds to the specific unique entity identifier; and calculate a score for the entity associated with the specific entity profile based on at least the transaction data included in one or more transaction data entries included in the specific entity profile. The transmitting device is configured to transmit the calculated score in an authorization message associated with the payment transaction.

Another system for evaluation of a small business profile includes an entity database, a receiving device, a processing device, and a transmitting device. The entity database is configured to store a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity. The receiving device is configured to receive a score request, wherein the score request includes a requested score and a set of one or more unique entity identifiers. The processing device is configured to: identify, in the entity database, a set of one or more entity profiles where the included unique entity identifier in each entity profile in the set of one or more entity profiles corresponds to the unique entity identifier in the set of one or more unique entity identifiers; and calculate the requested score for each entity associated with an entity profile in the identified set of one or more entity profiles based on at least the transaction data included in one or more transaction data entries included in the respective entity profile. The transmitting device is configured to transmit the calculated score for each entity associated with an entity profile in the identified set of one or more entity profiles in response to the received score request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for aggregating entity transactions and evaluating risk and spend profiles in accordance with exemplary embodiments.

FIG. 2 is a block diagram illustrating the processing server of FIG. 1 for aggregating transactions and evaluating profiles in accordance with exemplary embodiments.

FIG. 3 is a block diagram illustrating the aggregation of entity transactions in accordance with exemplary embodiments.

FIG. 4 is a flow diagram illustrating a process for evaluating a risk profile using the system of FIG. 1 in accordance with exemplary embodiments.

FIG. 5 is a flow diagram illustrating a process for evaluating small business spend profiles using the system of FIG. 1 in accordance with exemplary embodiments.

FIG. 6 is a flow chart illustrating an exemplary method for aggregating entity transaction data across multiple transaction accounts in accordance with exemplary embodiments.

FIGS. 7 and 8 are flow charts illustrating exemplary methods for evaluation of a small business profile in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, “commercial” payment accounts issued to consumers who are employed by corporations or who own a small business, etc., and may provide consumers with physical or non-physical means for accessing and/or utilizing such an account, such as debit cards, credit cards, prepaid cards, automated teller machine cards, electronic wallets, checks, etc.

### System for Aggregating Transactions and Evaluating Small Business Profiles

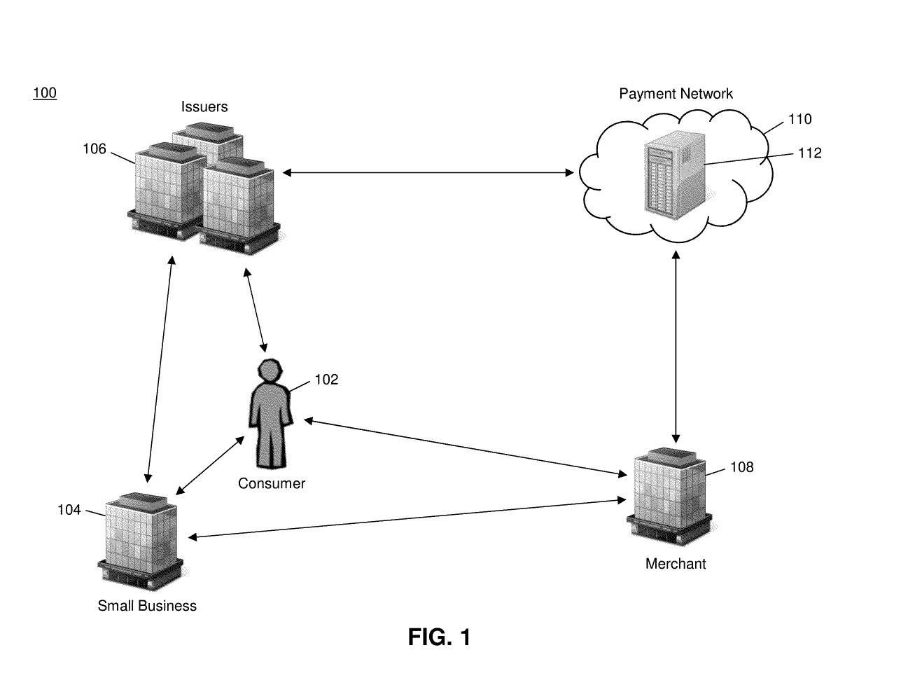

FIG. 1 illustrates a system 100 for the aggregation of transactions for an entity across multiple transaction accounts and the evaluation of profiles for a small business using the aggregated transaction data.

The system 100 may include a consumer 102. The consumer 102 may be the owner of a small business 104, may be an employee of the small business 104 with access to one or more business accounts of the small business 104, or may be an individual consumer not associated with a business. The consumer 102 and/or the small business 104 may have a plurality of transactions accounts held by one or more issuers 106. The issuers 106 may be banks or other financial institutions that provide transaction accounts to customers, such as the consumer 102 and small business 104.

In embodiments where the consumer 102 may be a small business owner, the consumer 102 may have a personal account with an issuer 106 and a business account associated with the small business 104 with the same issuer 106 or a different issuer 106. In other embodiments, the consumer 102 may only have personal accounts, such as multiple transaction accounts at one or more issuers 106. For example, the consumer 102 may have a savings account, a checking account, and a payment card account at a single issuer 106 or across multiple issuers 106. In another example, the small business 104 may have a business account at each of three separate issuers 106.

The consumer 102 and/or small business 104 may conduct payment transactions at a merchant 108. Payment transactions that involve the consumer 102 and/or small business 104 and the merchant 108 may be processed by a payment network 110, using methods and systems that will be apparent to persons having skill in the relevant art. The processing of payment transactions may involve providing transaction details to the issuer 106 associated with the transaction account being used to fund the payment transaction for approval of the payment transaction using known methods and systems.

The payment network 110 may include a processing server 112. The processing server 112, discussed in more detail below, may be configured to store transaction data for the processed payment transactions. The processing server 112 may also be configured to aggregate transaction data for each of the transaction accounts associated with a small business 104 and/or consumer 102. For example, the processing server 112 may aggregate the transaction data for transactions involving the consumer's 102 personal account and the small business's 104 business account into a single entity profile.

By aggregating the transaction data into a single profile, the processing server 112 may be able to provide a more complete profile of the transaction behavior of the consumer 102 and/or small business 104. In instances where a consumer 102, such as a small business owner, and their small business 104 are part of a single profile, the processing server 112 may be able to provide a combined set of transaction behavior for the business owner and their small business 104 that would otherwise be unavailable using traditional methods and systems. Such a complete profile may be beneficial for the providing of services to the business owner or their small business 104.

One such service may include the providing of a risk or spend profile for the small business 104 or consumer 102 based on the aggregated transaction history. In such a service, the processing server 112 may be configured to identify the transaction data in an entity profile associated with the consumer 102 and/or small business 104. The processing server 112 may then evaluate the risk and/or spend profile of the consumer 102 and/or small business 104 based on the aggregated transaction data using one or more rules or algorithms. Rules and algorithms used to evaluate the risk of an entity or to evaluate the spend behavior of an entity using transaction data will be apparent to persons having skill in the relevant art.

In some embodiments, the risk or spend profile of a small business 104 or consumer 102 may be evaluated as part of a payment transaction. In such an embodiment, when the merchant 108 submits an authorization request for a payment transaction to the payment network 110, the processing server 112 may be configured to evaluate the risk profile for the entity involved in the payment transaction using their aggregated transaction history. The risk profile may then be provided to the issuer 106 along with the other transaction data, for use in a decision to approve or deny the transaction.

In other embodiments, risk or spend profiles may be provided to entities upon request. For instance, an issuer 106, a merchant 108, an advertiser, a content provider, or other entity may request the spend profile for one or more consumers 102 and/or small businesses 104. The processing server 112 may receive the request, identify the corresponding entity profiles, evaluate the risk or spend profiles as requested, and transmit the evaluated risk or spend profiles in response to the received request. In some instances, the request may specify what is to be evaluated in the profile, such as a specific type of risk or a specific type of spend behavior. In some embodiments, the processing server 112 may request itself to produce a risk or spend profile, such as regularly evaluating a risk profile for small businesses 104 at predetermined intervals, such as for use in the processing of payment transactions.

By evaluating the risk or spend profile for an entity using aggregated transaction data, the processing server 112 may be able to provide a more accurate and/or more effective profile than using traditional systems. For example, a small business 104 that has a business account without significant assets or a significant transaction history may traditionally have a risk profile that indicates a high risk. However, the small business 104 may be owned by an owner that has a large amount of assets with a strong transaction history and high credit. The processing server 102 may evaluate the risk profile based on the aggregated history of both the small business 104 and the owner, which may more accurately determine the small business 104 to have less of a risk than using traditional systems. As a result, evaluations performed by the processing server 112 using the methods and systems discussed herein may have a higher degree of accuracy than in traditional evaluations.

### Processing Server

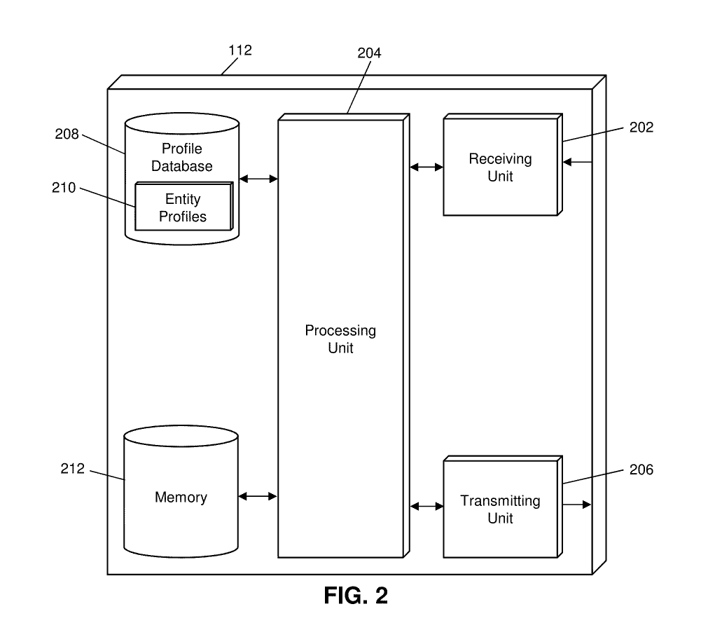

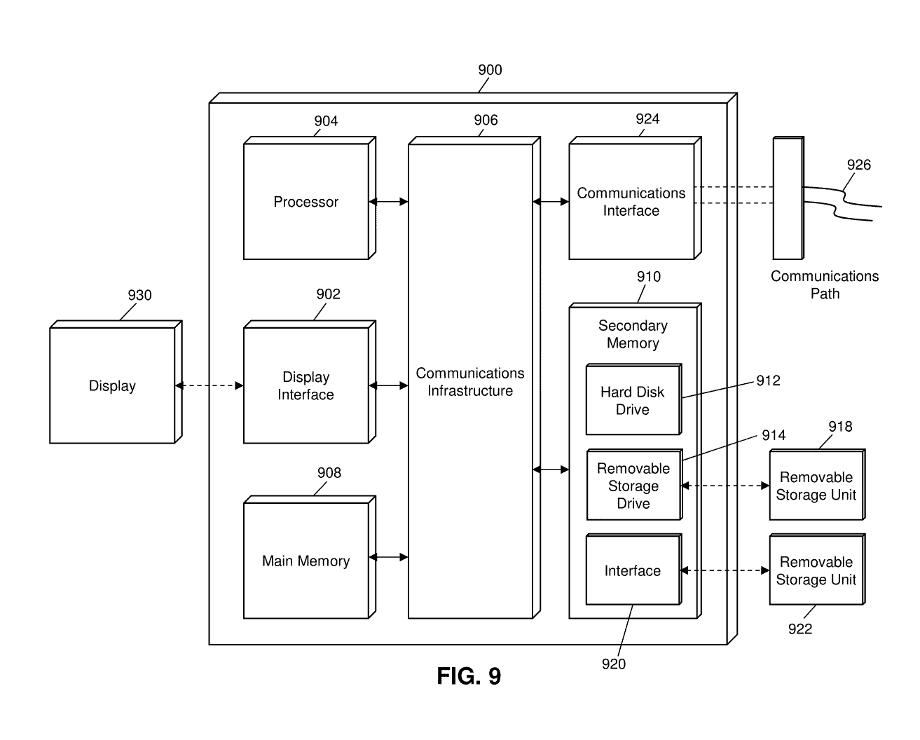

FIG. 2 illustrates an embodiment of the processing server 112 of the system 100. It will be apparent to persons having skill in the relevant art that the embodiment of the processing server 112 illustrated in FIG. 2 is provided as illustration only and may not be exhaustive to all possible configurations of the processing server 112 suitable for performing the functions as discussed herein. For example, the computer system 900 illustrated in FIG. 9 and discussed in more detail below may be a suitable configuration of the processing server 112.

The processing server 112 may include a receiving unit 202. The receiving unit 202 may be configured to receive data over one or more networks via one or more network protocols. The receiving unit 202 may receive transaction data from the payment network 110 for a plurality of payment transactions. The received transaction data may include an entity identifier associated with an entity involved in the respective transaction and an account identifier associated with an entity involved in the respective transaction, as discussed in more detail below. The receiving unit 202 may also be configured to receive requests for risk or spend profiles. The request may include one or more entity identifiers for which a risk or spend profile is requested. The request may also include information indicating what data is requested, such as types of risks or spend behaviors.

The processing server 112 may also include a processing unit 204. The processing unit 204 may be configured to perform the functions of the processing server 112 discussed herein as will be apparent to persons having skill in the relevant art. The processing unit 204 may store the received transaction data in a profile database 208. The profile database 208 may include a plurality of entity profiles 210. Each entity profile 210 may include data related to an entity and include at least a unique entity identifier and a plurality of transaction data entries. Each transaction data entry may include data associated with a payment transaction involving one of a plurality of transaction accounts associated with the related entity.

The unique entity identifier may be a unique value associated with the related entity suitable for identification of the entity and/or the related entity profile 210. The unique entity identifier may be, for example, an identification number, a reference number, a tax identification number, a username, an e-mail address, a telephone number, a street address, or other suitable value that will be apparent to persons having skill in the relevant art. Each transaction data entry may include an account identifier associated with the transaction account involved in the related payment transaction. The account identifier may be a unique value associated with the transaction account, such as an account number, username, e-mail address, telephone number, or other suitable value. In some embodiments, the entity unique identifier for an entity profile 210 may be different from each account identifier associated with a transaction account associated with the related entity.

The processing unit 204 may store received transaction data in a corresponding entity profile 210 based on the entity identifier included in the received transaction data and the entity identifier included in the entity profile 210. The processing unit 204 may also be configured to calculate a score for an entity profile 210. The score may be a score representative of a risk or spend behavior of the related entity and may be based on transaction data for each of the transaction data entries included in the entity profile 210. Transaction data used to calculate the score may include transaction amounts, transaction times and/or dates, geographic locations, product data, merchant data, point of sale data, payment data, etc.

Scores may be calculated by the processing unit 204 using one or more rules or algorithms. The rules or algorithms may be stored in a memory 212 of the processing server 112. The memory 212 may be configured to store data suitable for performing the functions of the processing server 112 discussed herein as will be apparent to persons having skill in the relevant art. For example, the memory 212 may store the rules or algorithms used to calculate the risk or spend profile scores, rules for initiating the calculation of risk or spend profile scores, rules for evaluating a risk or spend profile based on a calculated score, etc. Rules or algorithms used to calculate a risk score or spend behavior based on transaction data will be apparent to persons having skill in the relevant art.

In some embodiments, calculated risk scores and spend behaviors may be further based on the transaction account associated with each transaction data entry in the spend profile 210. For instance, a scoring algorithm may be configured to score transactions associated with personal accounts differently than transactions associated with business accounts. In another example, calculated risk scores may be based wholly or in part on a proportion of business account transactions to personal account transactions, such as based on transaction frequency, transaction amounts, etc.

The processing server 112 may also include a transmitting unit 206. The transmitting unit 206 may be configured to transmit data over one or more networks via one or more network protocols. The transmitting unit 206 may transmit calculated risk scores or spending behaviors, such as in response to a received request. In some embodiments, the transmitting unit 206 may transmit a calculated risk score or spend behavior, or subsequent evaluation, to a third party in response to a request initiated by the processing unit 204, such as at a predetermined period of time.

### Aggregation of Entity Transaction Data

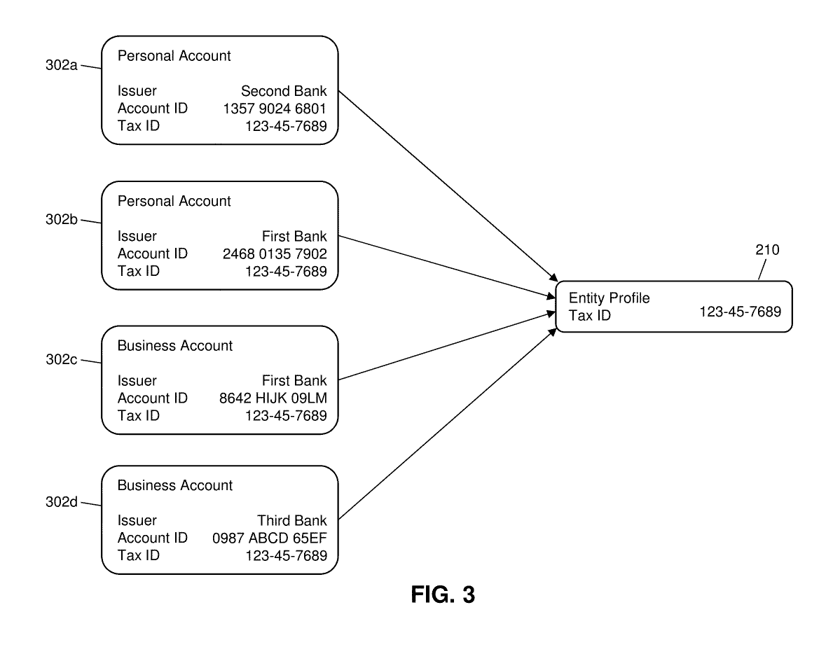

FIG. 3 illustrates the aggregation of payment transactions for a plurality of transaction accounts all associated with a single entity.

A small business owner may have a plurality of transaction accounts 302 across multiple issuers 106. As illustrated in the example in FIG. 3, the small business owner may have a personal account 302a with Second Bank, a personal account 302b with First Bank, a business account 302c for their small business 104 with First Bank, and a business account 302d for their small business 104 with Third Bank. Each of the transaction accounts 302 may have an account identifier associated with the respective account, such as the account identifier 135790246801 associated with the personal account 302a.

Each transaction account 302 may also be associated with a unique entity identifier associated with the small business owner. In the example illustrated in FIG. 3, the unique entity identifier may be a tax identification number associated with the unique entity identifier having the value of 123-45-7689. Transaction accounts 302 may include personal accounts and business accounts held by an issuer 106 or other financial institution, and may also include reward accounts, loyalty accounts, charge accounts, user accounts, and other types of transaction accounts suitable for use in the methods and systems discussed herein as will be apparent to persons having skill in the relevant art.

Using the unique entity identifier that is associated with the entity associated with each of the transaction accounts 302, the processing server 112 may generate an entity profile 210 to aggregate the transaction data for each of the transaction accounts 302. The entity profile 210 may include the tax identification number as the unique entity identifier and may store transaction data entries for each payment transaction involving one of the four transaction accounts 302 based on the included account identifiers.

### Process for Scoring Risk Using Aggregated Transaction Data

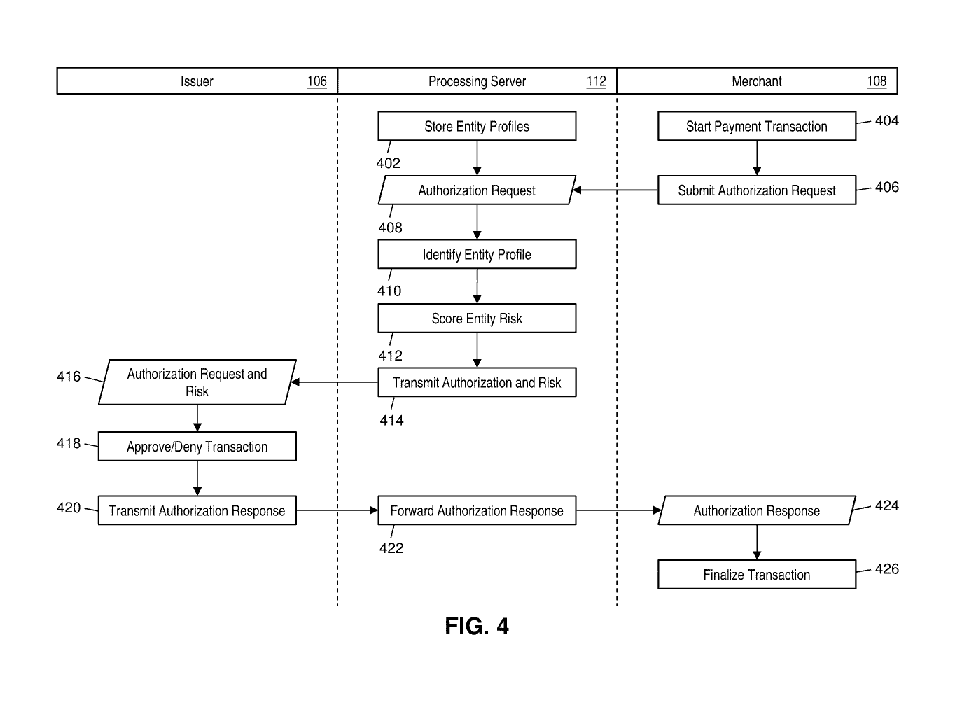

FIG. 4 illustrates a process for the aggregation of transaction data across multiple transaction accounts for an entity.

In step 402, the processing server 112 may store a plurality of entity profiles 210, wherein each entity profile 210 includes data related to an entity including a unique entity identifier and a plurality of transaction data entries for payment transactions involving one of a plurality of transaction accounts associated with the related entity. In some embodiments, the related entity may be a small business, and the transaction accounts may be associated with the small business and/or the owner of the small business. In step 404, the merchant 108 may initiate a payment transaction with an entity, such as a consumer 102 business owner or a small business 104. In step 406, the merchant 108 (e.g., or an acquiring financial institution on behalf of the merchant 108) may submit an authorization request for the payment transaction to the processing server 112 (e.g., via the payment network 110).

In step 408, the receiving unit 202 of the processing server 112 may receive the authorization request. The authorization request may include at least an account identifier associated with a transaction account used to fund the payment transaction and a specific unique entity identifier associated with the transaction account. In step 410, the processing unit 204 of the processing server 112 may identify a specific entity profile 210 in the profile database 208 that includes the specific unique entity identifier included in the received authorization request.

In step 412, the processing unit 204 may calculate a risk score for the entity based on the transaction data included in the transaction data entries in the identified specific entity profile 210. The risk score may be calculated using one or more rules or algorithms, which may be stored in the memory 212 of the processing server 112. In some embodiments, transaction data for the current payment transaction, as included in the authorization request, may be used in the calculation of the risk score. In step 414, the transmitting unit 206 of the processing server 112 may transmit the authorization request and the calculated risk score to an issuer 106 associated with the transaction account used to fund the payment transaction.

In step 416, the issuer 106 may receive the authorization request and the calculated risk score, and, in step 418, may approve or deny the payment transaction based on the calculated risk score and other criteria. Criteria used by an issuing financial institution in the approval or denial of a payment transaction will be apparent to persons having skill in the relevant art. In step 420, the issuer 106 may transmit an authorization response back to the processing server 112 that indicates if the transaction was approved or denied.

In step 422, the receiving unit 202 may receive the authorization response and the transmitting unit 206 may forward it along to the merchant 108. In step 424, the merchant 108 may receive the authorization response indicating approval or denial of the payment transaction. Then, in step 426, the merchant 108 may finalize the transaction accordingly, such as by providing purchased goods or services to the entity, furnishing a receipt, etc.

### Process for Evaluating Spend Profiles Using Aggregate Transaction Data

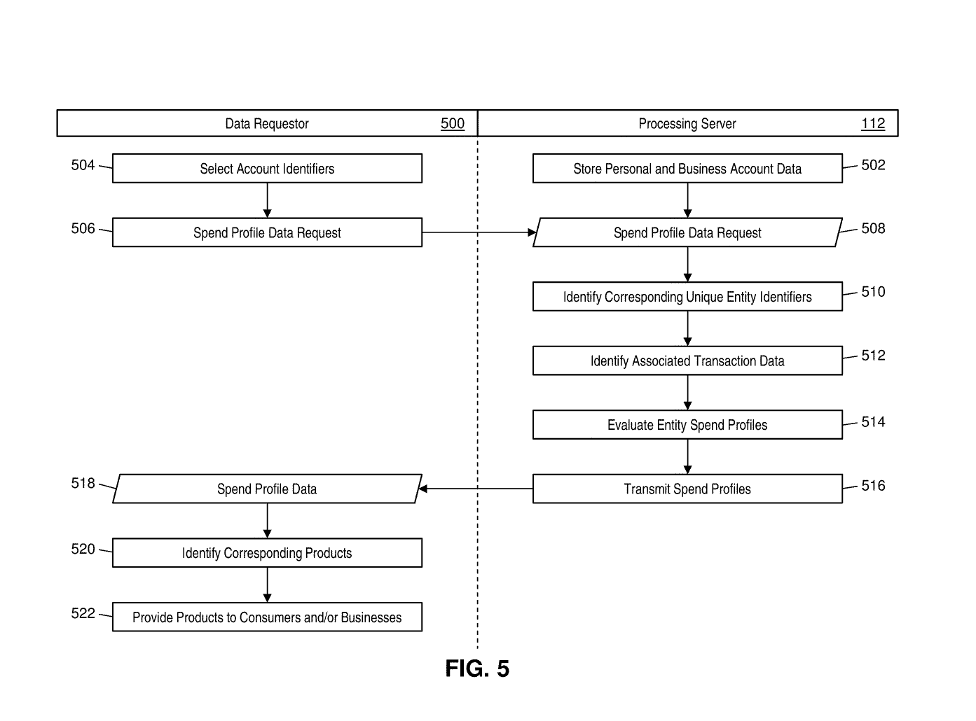

FIG. 5 illustrates a process for the evaluation of spend profiles for an entity based on aggregate transaction data for payment transactions across a plurality of transaction accounts.

In step 502, the processing server 112 may store transaction data for a plurality of personal and business accounts, such as transaction accounts 302 associated with a consumer 102 business owner and their small business 104, in an entity profile 210 in the profile database 208 for a plurality of different entities. Each entity profile 210 may include the transaction data and a unique entity identifier associated with the related entity.

In step 504, a data requestor 500, such as an advertiser, content provider, merchant 108, issuer 106, etc., may select a plurality of account identifiers associated with transaction accounts for which the data requestor 500 desires a spend profile. In step 506, the data requestor 500 may transmit a spend profile data request to the processing server 112. In step 508, the receiving unit 202 of the processing server 112 may receive the spend profile data request. The spend profile data request may include the plurality of account identifiers, and may also include one or more requested spend behaviors.

In step 510, the processing unit 204 may identify a corresponding unique entity identifier for each of the account identifiers included in the received spend profile data request. The corresponding unique entity identifiers may be identified using the profile database 208, a look-up table (e.g., stored in a database, such as the memory 212), or other suitable method. In step 512, the processing unit 204 may identify transaction data associated with each of the account identifiers by identifying transaction data included in an entity profile 210 that includes the corresponding unique entity identifier.

In step 514, the processing unit 204 may evaluate a spend profile for each of the entities. Evaluation of the spend profile may include calculating one or more spend or purchase behaviors for the entity based on the identified transaction data. Spend behaviors can include propensities to spend on a plurality of merchants, categories, industries, products, etc., in one or more geographic locations, during one or more periods of time, or based on other suitable criteria, such as weather, season, time of day, time of week, time of month, account status, demographic characteristics, or other criteria that will be apparent to persons having skill in the relevant art. In some embodiments, the spend behaviors calculated may be spend behaviors indicated in the received spend profile data request.

In step 516, the transmitting unit 206 of the processing server 112 may transmit the calculated spend behaviors to the data requestor 500. In step 518, the data requestor 500 may receive the spend behaviors and any other accompanying profile data. In step 520, the data requestor 500 may identify products, content, or other items to provide to the entities based on their respective calculated spend behaviors. In step 522, the identified items may be provided to the entity consumers 102 and/or small businesses 104.

### Exemplary Method for Aggregating Entity Transaction Data Across Multiple Transaction Accounts

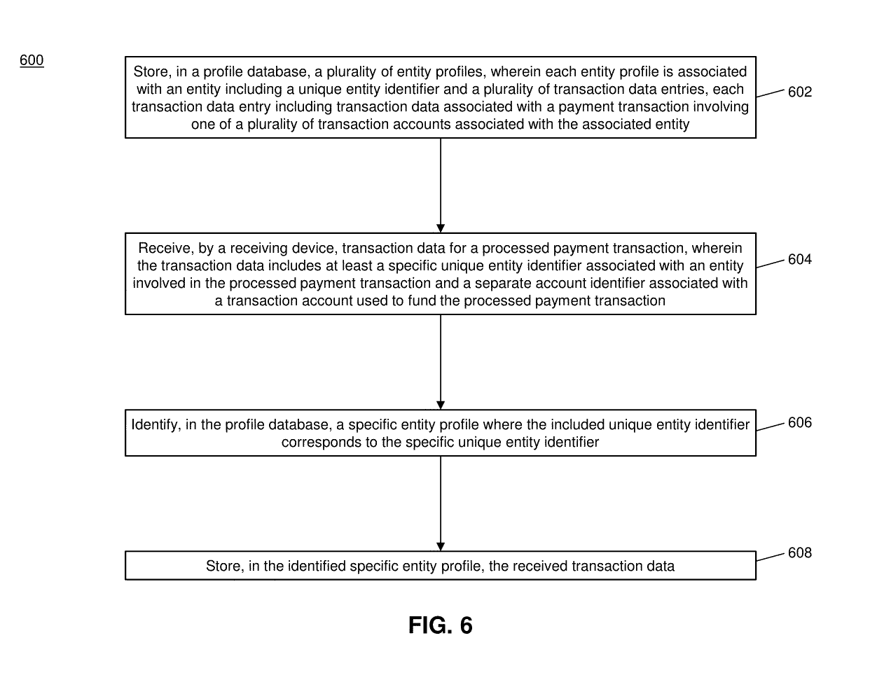

FIG. 6 illustrates a method 600 for the aggregation of entity transaction data across multiple transaction accounts via a unique entity identifier.

In step 602, a plurality of entity profiles (e.g., entity profiles 210) may be stored in a profile database (e.g., the profile database 208), wherein each entity profile 210 is associated with an entity including a unique entity identifier and a plurality of transaction data entries, each transaction data entry including transaction data associated with a payment transaction involving one of a plurality of transaction accounts associated with the associated entity. In one embodiment, the plurality of transaction accounts may include business accounts and personal accounts. In some embodiments, the transaction data included in each transaction data entry includes an account identifier associated with the involved transaction account of the plurality of transaction accounts.

In one embodiment, the plurality of transaction accounts may be held by at least two different financial institutions. In some embodiments, the unique identifier may not include an account identifier associated with any of the plurality of transaction accounts associated with the associated entity. In step 604, transaction data for a processed payment transaction may be received by a receiving device (e.g., the receiving unit 202), wherein the transaction data includes at least a specific unique entity identifier associated with an entity involved in the processed payment transaction and a separate account identifier associated with a transaction account used to fund the processed payment transaction.

In step 606, a specific entity profile 210 may be identified in the profile database 208 where the included unique entity identifier corresponds to the specific unique entity identifier. In one embodiment, the entity associated with the specific entity profile 210 may be a small business owner, and the plurality of transaction accounts may include at least one personal account associated with the small business owner and one business account associated with a small business (e.g., the small business 104) owned by the small business owner. In step 608, the received transaction data may be stored in the identified specific entity profile 210.

### First Exemplary Method for Evaluation of a Small Business Profile

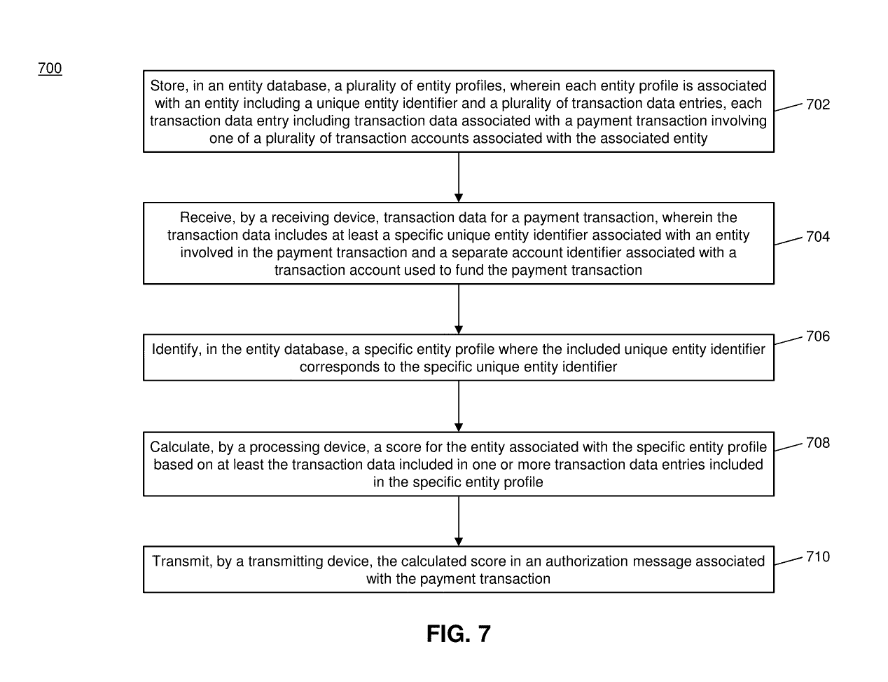

FIG. 7 illustrates a method 700 for the evaluation of a small business profile for a small business based on aggregated transaction data for a plurality of transaction accounts associated with the small business.

In step 702, a plurality of entity profiles (e.g., entity profiles 210) may be stored in an entity database (e.g., the profile database 208), wherein each entity profile 210 is associated with an entity (e.g., the small business 104) including a unique entity identifier and a plurality of transaction data entries, each transaction data entry including transaction data associated with a payment transaction involving one of a plurality of transaction accounts associated with the associated entity. In one embodiment, the plurality of transaction accounts may include business accounts and personal accounts. In some embodiments, the plurality of transaction accounts may be held by at least two different financial institutions.

In step 704, transaction data for a payment transaction may be received by a receiving device (e.g., the receiving unit 202), wherein the transaction data includes at least a specific unique entity identifier associated with an entity involved in the payment transaction and a separate account identifier associated with a transaction account used to fund the payment transaction. In step 706, a specific entity profile 210 may be identified in the entity database 208 where the included unique entity identifier corresponds to the specific unique entity identifier. In some embodiments, the entity associated with the specific entity profile 210 may be a small business owner, and the plurality of transaction accounts includes at least one personal account associated with the small business owner and at least one business account associated with small business (e.g., the small business 104) owned by the small business owner.

In step 708, a score may be calculated for the entity associate with the specific entity profile 210 by a processing device (e.g., the processing unit 204) based on at least the transaction data included in one or more transaction data entries included in the specific entity profile 210. In some embodiments, the score may be further based on the received transaction data for the payment transaction. In some embodiments, the calculated score may be at least one of: a risk score representative of a risk of the entity associated with the specific entity profile 210 and a behavior score representative of a spend behavior of the entity associated with the specific entity profile 210. In one embodiment, the calculated score may be based on at least a proportion of transaction data entries associated with payment transactions involving personal accounts to transaction data entries associated with payment transactions involving business accounts.

In step 710, the calculated score may be transmitted by a transmitting device (e.g., the transmitting unit 206) in an authorization message associated with the payment transaction.

### Second Exemplary Method for Evaluation of a Small Business Profile

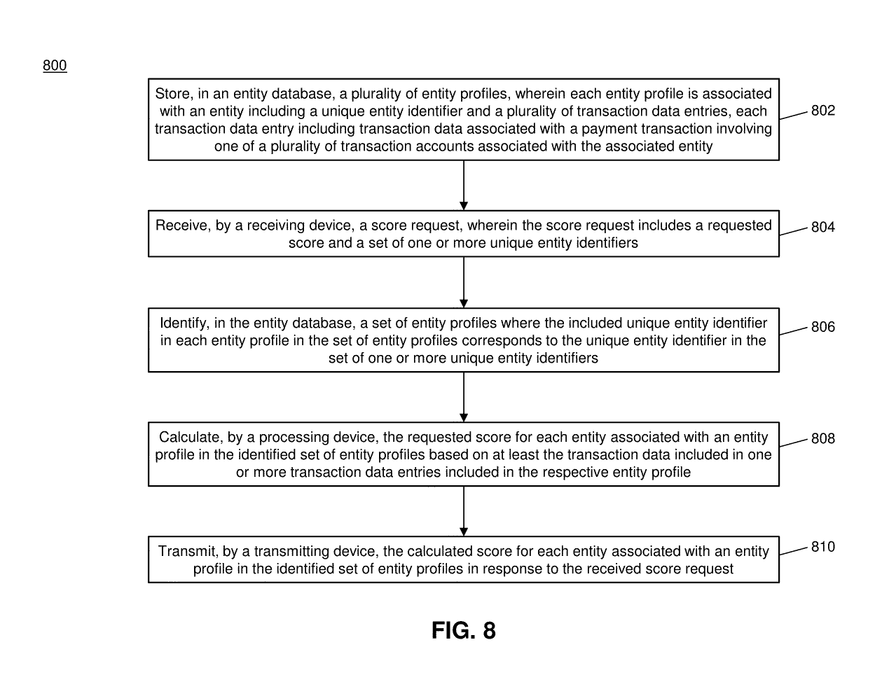

FIG. 8 illustrates a method 800 for the evaluation of a small business profile for one or more small businesses or other entities based on aggregated transaction data for a plurality of transaction accounts associated with the respective entity.

In step 802, a plurality of entity profiles (e.g., entity profiles 210) may be stored in an entity database (e.g., the profile database 208), wherein each entity profile 210 is associated with an entity including a unique entity identifier and a plurality of transaction data entries, each transaction data entry including transaction data associated with a payment transaction involving one of a plurality of transaction accounts associated with the associated entity. In some embodiments, the plurality of transaction accounts may include business accounts and personal accounts. In one embodiment, the plurality of transaction accounts may be held by at least two different financial institutions.

In step 804, a score request may be received by a receiving device (e.g., the receiving unit 202), wherein the score request includes a requested score and a set of one or more unique entity identifiers. In one embodiment, the score may be transmitted by a processing device (e.g., the processing unit 204). In a further embodiment, the processing device 204 may be included in the same computing device (e.g., the processing server 112) as the receiving device 202.

In step 806, a set of entity profiles may be identified in the entity database 208 where the included unique entity identifier in each entity profile 210 in the set of entity profiles corresponds to the unique entity identifier in the set of one or more unique entity identifiers. In some embodiments, the entity associated with each entity profile 210 in the set of entity profiles may be a small business owner, and the plurality of transaction accounts may include at least one personal account associated with the small business owner and at least one business account associated with a small business (e.g., the small business 104) owned by the small business owner.

In step 808, the requested score may be calculated by the processing device 204 for each entity associated with an entity profile 210 in the identified set of entity profiles based on at least the transaction data included in one or more transaction data entries included in the respective entity profile 210. In some embodiments, the calculated score may be at least one of: a risk score representative of a risk of the respective entity and a behavior score representative of a spend behavior of the respective entity.

In one embodiment, the calculated score may be based on at least a proportion of transaction data entries associated with payment transactions involving personal accounts to transaction data entries associated with payment transactions involving business accounts. In step 810, the calculated score may be transmitted by a transmitting device (e.g., the transmitting unit 206) for each entity associated with an entity profile 210 in the identified set of entity profiles in response to the received score request.

### Computer System Architecture

FIG. 9 illustrates a computer system 900 in which embodiments of the present disclosure, or portions thereof, may be implemented as computer-readable code. For example, the processing server 112 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 4-8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for aggregating entity transaction data and evaluating a small business profile based on aggregated transaction data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for evaluation of a small business profile, comprising:
storing, in an entity database, a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity;
receiving, by a receiving device, a score request, wherein the score request includes a requested score and a set of one or more unique entity identifiers;
identifying, in the entity database, a set of one or more entity profiles where the included unique entity identifier in each entity profile in the set of one or more entity profiles corresponds to the unique entity identifier in the set of one or more unique entity identifiers;
calculating, by a processing device, the requested score for each entity associated with an entity profile in the identified set of one or more entity profiles based on at least the transaction data included in one or more transaction data entries included in the respective entity profile; and
transmitting, by a transmitting device, the calculated score for each entity associated with an entity profile in the identified set of one or more entity profiles in response to the received score request.

2. The method of claim 1, wherein the calculated score is at least one of: a risk score representative of a risk of the respective entity, and a behavior score representative of a spend behavior of the respective entity.

3. The method of claim 1, wherein
the entity associated with each entity profile in the set of entity profiles is a small business owner, and
the plurality of transaction accounts includes at least one personal account associated with the small business owner and at least one business account associated with a small business owned by the small business owner.

4. The method of claim 1, wherein the calculated score is based on at least a proportion of transaction data entries associated with payment transactions involving personal accounts to transaction data entries associated with payment transactions involving business accounts.

5. A system for aggregating entity transaction data across multiple transaction accounts, comprising:
a profile database configured to store a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity;
a receiving device configured to receive transaction data for a processed payment transaction, wherein the transaction data includes at least a specific unique entity identifier associated with an entity involved in the processed payment transaction and a separate account identifier associated with a transaction account used to fund the processed payment transaction; and
a processing device configured to
identify, in the profile database, a specific entity profile where the included unique entity identifier corresponds to the specific unique entity identifier, and
store, in the identified specific entity profile, the received transaction data.

6. The system of claim 5, wherein the transaction data included in each transaction data entry includes an account identifier associated with the involved transaction account of the plurality of transaction accounts.

7. The system of claim 5, wherein
the entity associated with the specific entity profile is a small business owner, and
the plurality of transaction accounts includes at least one personal account associated with the small business owner and at least one business account associated with a small business owned by the small business owner.

8. The system of claim 5, wherein the unique entity identifier does not include an account identifier associated with any of the plurality of transaction accounts associated with the associated entity.

9. A system for evaluation of a small business profile, comprising:
an entity database configured to store a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity;
a receiving device configured to receive transaction data for a payment transaction, wherein the transaction data includes at least a specific unique entity identifier associated with an entity involved in the payment transaction and a separate account identifier associated with a transaction account used to fund the payment transaction;
a processing device configured to
identify, in the entity database, a specific entity profile where the included unique entity identifier corresponds to the specific unique entity identifier, and
calculate a score for the entity associated with the specific entity profile based on at least the transaction data included in one or more transaction data entries included in the specific entity profile; and
a transmitting device configured to transmit the calculated score in an authorization message associated with the payment transaction.

10. The system of claim 9, wherein the calculated score is at least one of: a risk score representative of a risk of the entity associated with the specific entity profile, and a behavior score representative of a spend behavior of the entity associated with the specific entity profile.

11. The system of claim 9, wherein
the entity associated with the specific entity profile is a small business owner, and
the plurality of transaction accounts includes at least one personal account associated with the small business owner and at least one business account associated with a small business owned by the small business owner.

12. The system of claim 9, wherein the calculated score is based on at least a proportion of transaction data entries associated with payment transactions involving personal accounts to transaction data entries associated with payment transactions involving business accounts.

13. A system for evaluation of a small business profile, comprising:
an entity database configured to store a plurality of entity profiles, wherein each entity profile is associated with an entity including a unique entity identifier and a plurality of transaction data entries, each transaction data entry including transaction data associated with a payment transaction involving one of a plurality of transaction accounts associated with the associated entity;
a receiving device configured to receive a score request, wherein the score request includes a requested score and a set of one or more unique entity identifiers;
a processing device configured to
identify, in the entity database, a set of one or more entity profiles where the included unique entity identifier in each entity profile in the set of one or more entity profiles corresponds to the unique entity identifier in the set of one or more unique entity identifiers, and
calculate the requested score for each entity associated with an entity profile in the identified set of one or more entity profiles based on at least the transaction data included in one or more transaction data entries included in the respective entity profile; and
a transmitting device configured to transmit the calculated score for each entity associated with an entity profile in the identified set of one or more entity profiles in response to the received score request.

14. The system of claim 13, wherein the calculated score is at least one of: a risk score representative of a risk of the respective entity, and a behavior score representative of a spend behavior of the respective entity.

15. The system of claim 13, wherein the plurality of transaction accounts include business accounts and personal accounts.

16. The system of claim 13, wherein
the entity associated with each entity profile in the set of entity profiles is a small business owner, and
the plurality of transaction accounts includes at least one personal account associated with the small business owner and at least one business account associated with a small business owned by the small business owner.

17. The system of claim 13, wherein the plurality of transaction accounts are held by at least two different financial institutions.

18. The system of claim 13, wherein the calculated score is based on at least a proportion of transaction data entries associated with payment transactions involving personal accounts to transaction data entries associated with payment transactions involving business accounts.
